(19) United States
(12) Patent Application Publication
(10) Pub. No.: US 2018/0057901 A1
(43) Pub. Date: Mar. 1, 2018

(54) Method and device for granulating molten material

(71) Applicant: RADMAT AG, Aesch/Luzern (CH)

(72) Inventor: Alfred EDLINGER, Bartholomäberg (AT)

(73) Assignee: RADMAT AG, Aesch/Luzem (CH)

(21) Appl. No.: 15/557,264

(22) PCT Filed: Mar. 14, 2016
(86) PCT No.: PCT/AT2016/000027

§ 371 Date: Sep. 11, 2017

(30) Foreign Application Priority Data
Mar. 13, 2015 (AT) A142/2015

(51) Int. Cl. C21B 3/08; C04B 5/06; B01J 2/12

(52) U.S. Cl. CPC C21B 3/08; C21B 2300/02; B01J 2/12; C04B 5/06

(57) ABSTRACT

For a method for granulating molten material, in particular slags, in which the molten material is introduced into a granulating chamber in which water is held as a cooling liquid, wherein the molten material is preferably quenched and granulated with evaporation of the water, an acid is added to the water.

The invention relates to a method for granulating molten material, in particular slags, in which the molten material is introduced into a granulating chamber in which water is held as a cooling liquid, wherein the molten material is preferably quenched and granulated by evaporation of the water.

Furthermore, the invention relates to a device for performing this method.

Mineral melts, for example, blast furnace slags, are usually granulated with the aid of water in order to obtain an amorphous product which solidifies in the glass phase, i.e., a metastable phase. After a grinding operation, such a product can be admixed as latently hydraulically active component to cements. In such a method, the melt heat of the melt flow is converted into a low-temperature heat of water and is not usable any further.

Mineral melts, for example, blast furnace slags, must be cooled extremely rapidly (about 10³ K/sec) below their recrystallization point (depending on the basicity, between about 600 and 850° C.) in order to obtain a cement-based amorphous product. Under this recrystallization temperature a substantially lower cooling gradient is sufficient.

In order to increase the slag-glass content of the granulate and to improve the slag grindability with respect to cold-water granulation, a boiling water granulation has been proposed in WO 01/051674 A1 in which the molten melt is introduced into a cooling water brought to boiling temperature. As a result, the latent evaporation enthalpy of the cooling water is available for rapid cooling, through which the slag-glass content is maximized. The granules surprisingly have a very low apparent density and float on the boiling water, which improves the slag grindability significantly compared to the grindability when using cold water granulation. The granulate itself is discharged from the boiling water at a temperature which exceeds the boiling temperature of the water, wherein the retained water already evaporates during the granulation discharge, so that a dry granulate is formed immediately. Since water is discharged together with the granulate only in steam form, there is also no sewage problem. Steam is subsequently condensed and, together with additional water, is recycled to the granulator in order to cover the loss of water vapor. The secondary products formed during the slag-water reaction, such as, for example, H₂S, remain in the condensation of the water in the gas phase and are in concentrated form here, so that a reasonable and economical reprocessing can be achieved.

In addition to blast furnace slags, various slags such as, for example, steel mill slags, non-ferrous metallurgical slags, artificial slags such as slags from the primary Al electrolysis (spent potliner slagged with lime carriers) have impurities. This also applies in particular to highly problematic dusts from metallurgy, cement production (cement kiln bypass dusts) and waste incineration, which are to be slagged.

These impurities on the one hand make them impossible to use as active binders (e.g., in cements); on the other hand, these are problematic environmentally and can only partially be deposited in special waste disposal sites. Such impurities are, for example, compounds of F, Cl, alkalies, S, heavy metals (e.g., Cr, V, Ni, Mo, Cu, Sn, Zn, Cd, Hg) and rare earths but also Fe and free lime or unreacted CaO and MgO.

The invention therefore aims to granulate molten material, in particular slags, in an energy-efficient manner, wherein the impurities mentioned are to be separated off in a simple manner or converted into usable substances. At the same time, the resulting granulate is to have a particularly high reactivity, for example, in order to be used in the cement industry.

In order to achieve this object, the invention provides, in the case of a method of the type mentioned at the outset, that an acid is added to the water. Preferably, a mineral acid, in particular sulfuric acid, hydrochloric acid, nitric acid or phosphoric acid, or an organic acid, in particular formic acid, acetic acid, fatty acid (e.g., stearic acid) or ligninsulfonic acid, or mixtures thereof, can be used as an acid. Particular preference is given to the use of sulfuric acid. Furthermore, a mixture of at least one mineral acid with at least one organic acid is preferred.

The granulation is thus performed using an acid bath, wherein numerous advantageous effects are obtained for the widest variety of molten input materials.

The liquid melt solidifies on contact with the acid bath from the outside, wherein part of the acid bath evaporates. As a result, the turbulent flow and the bubble formation of the boiling acid bath result in further input of mechanical forces in the reactor and consequently to further comminution of the melt particles, which also promotes heat transfer.

A sulfating granulation is achieved through the presence of sulfuric acid in the granulating water, in which sulfation takes place on the micro level of the solidifying particles. This results in an increase in defects in the micro-structure of the granulated material, i.e., the incorporation of foreign bodies at the molecular level, wherein the sulfation results in a drastic increase in the hydraulic activity as part of the use of the granulate as a hydraulic binder or as a mixing component in cements. As a result, the early strength of the binder can be significantly increased.

It has been found that the sulfation reaction or the etching of lime-silicate melts primarily leads to the reaction products colloidal silica, various modifications of Ca(SO₄)₂, such as, for example, gypsum, anhydrite and/or hemihydrate, which are responsible for the early strength of the cement. Depending on the content of further melt main constituents such as, for example, MgO, Al₂O₃, Fe₂O₃, their sulfates or further by-products such as ettringite, zeolites etc. are evident. All these groups of substances possess interesting properties in terms of cement technology. Similar reactions have also been observed when using acids other than sulfuric acid, in particular acids which are stronger than silica. There are then no sulfates, but the corresponding alkaline earth salts, which, in contrast to the sulfates, may be water-soluble.

As a result of the water evaporation, which is extremely energy-dense, the melt is cooled very rapidly below the recrystallization temperature (depending on the basicity, between about 600 and 850° C.) above 10³ K/sec, whereby the granules accrue amorphous or nanocrystalline (with a basicity CaO/SiO₂ of greater than 1.8), which leads to optimum cement-technological properties.

Through this, the melt is quenched according to the invention by evaporation of water, the granulate comes in contact with liquid water to a lesser extent, which leads to the undesirable pre-hydration of cement-hydraulical active amorphous slags (CSH phase formation).

Furthermore, the addition of sulfuric acid to the granulating water results in the halogens contained in the slag, in particular F and Cl, and the sulfur compounds (sulfites, sulfides) present being converted into the acid anhydride form (HF, HCl, H₂S), which can be withdrawn with the steam bubbles and subsequently condensed to the corresponding acid. In particular, hydrofluoric acid has a high market value and can therefore be exploited in an economically advantageous manner.

A further effect of sulfuric acid is that the free lime present in the melt reacts with the sulfuric acid into largely insoluble gypsum (preferably as hemihydrate), which is required in the cement as a solidification regulator. A granulate which is essentially free from free lime is thus obtained. In the case of the use of the granulate as a hydraulic binder, the presence of free lime is undesirable from a cement-technological point of view because the free lime expands in the presence of water and thus breaks open the desired composite.

The present method is particularly suitable for the granulation of blast furnace slag. A blast furnace slag is understood here to mean a calcium silicate aluminate melt with the following main constituents:
CaO: >30% by weight, in particular 35-45% by weight,
SiO₂: >30% by weight, in particular 33-38% by weight,
Al₂O₃: >6% by weight, in particular 10-13% by weight

Further, optionally, 6-12% by weight of MgO, 0.1-0.5% by weight of Fe, 0.2-0.4% by weight of Mn, 0.3-0.5% by weight of Na₂O, 0.7-0.8% by weight of K₂O, 1.2-1.9% by weight of S, and/or □1% by weight of TiO₂ may be contained.

The present method is also suitable for the granulation of other slags, such as, for example, alloyed slags, which comprise the following main components:
CaO: >30% by weight, in particular 35-45% by weight,
SiO₂: >30% by weight, in particular 33-38% by weight,
Al₂O₃: >6% by weight, in particular 10-13% by weight.

In general, the method according to the invention is suitable and advantageous for melts that have a CaO/SiO₂ ratio of 0.6-1.6, in particular 0.85-1.4.

The present method is suitable not only for the granulation of blast furnace slag but also, in particular, for the granulation of steel mill slags. Steel mill slags contain alite and belite fractions embedded in the matrix, which are digested or released by the action of the acid contained in the granulating water, in particular sulfuric acid. Alite (tricalcium silicate, short C₃S) and belite (dicalcium silicate, short C₂S) are important components of Portland cement clinker. The granulate obtained according to the invention contains increased proportions of alite and belite and is therefore particularly suitable as a hydraulic binder or as a component of composite cements.

Steel mill slags also contain high proportions of iron and heavy metal compounds. Heavy metals, in particular chromium, in particular chromium (VI) oxide, are undesirable in the cement. The heavy metals present are readily acid-soluble and thus readily dissolve in the acid bath, in particular in the granulating water mixed with sulfuric acid. Iron is also dissolved and iron sulfate is formed. Sodium sulfate is formed in the presence of Na. Iron sulfate and sodium sulfate can advantageously be fed for further use. Iron sulfate is used, for example, in the treatment of wastewater for phosphate precipitation.

Steel mill slags are often mixed with dolomite as a base former. For this reason, steel mill slags may contain free MgO, which reacts with the sulfuric acid in the granulating chamber to form magnesium sulfate, which can subsequently be separated off.

Similarly, molten steel mill dusts can be granulated, wherein the heavy metals contained dissolve in the acid bath as described above.

Furthermore, it has been found that the method according to the invention is suitable for the granulation of a mixture of blast furnace slag and steel mill slag. The mixture preferably comprises 50-70% by weight, in particular about 60% by weight, of blast furnace slag and 30-50% by weight, in particular 40% by weight, of steel mill slag. Steel mill slag from the LD steel production is preferably used as a steel mill slag. Steel mill slag usually has an iron oxide content of 15-25% by weight and a chromium oxide content of 1200 ppm. The granulation of the slag mixture in sulfuric acid produces FeSO₄ (divalent Fe), FeSO₄ is usually added to the chromium-containing cement in order to avoid the formation of hexavalent Cr via the redox reaction. Thus, a latent-hydraulic binder can be produced by the method according to the invention, which can advantageously be used as a mixed cement component for producing an early-strength, chromium-stabilized cement.

The method according to the invention is also suitable for the processing and granulation of secondary slags, such as, for example, ladle slags, slag coverage and refining slags. Such slags are generally not recyclable and must therefore be disposed of. The slags have a high fluoride content, because fluorspar has been added to liquefy the slag melt. In the sulfuric acid bath, fluorine is released as hydrofluoric acid, which goes into the gas phase and can be deposited in a simple manner after condensation.

When using highly basic slag melts as part of the method according to the invention, for example of LD steel mill slags, arc furnace slags, ladle slags and secondary slags, it is preferred for the basicity (CaO/SiO₂) of the slag to be adjusted to a value of 0.85-1.4. The setting can preferably be performed by adding acidic components such as, for example, quartz sand, used foundry sand, blast furnace slag, fine dust from waste incineration plants, fly ash from coal-fired power plants.

The method according to the invention is also suitable for the processing of consumed carbon-containing cathode material, in particular spent cathode trays from aluminum production. Used cathode trays, also known as spent pot liners, are found in large quantities in aluminum production according to the Hall-Héroult process and have always been a problem in their disposal due to their high content of toxins. Spent pot liners are mixed with lime and smelted in a pre-process. The melt is then freed of carbon (e.g., gasified in a shaft furnace or dissolved in an iron bath) and slag is produced, which essentially contains calcium fluoroaluminate. In the granulation of such a slag according to the invention using an acid bath, in particular sulfuric acid, calcium fluoroaluminate is converted into amorphous or semicrystalline calcium sulfoaluminate, wherein additional hydrofluoric acid is formed. Calcium sulfoaluminate is hydraulically highly reactive and is used, for example, as an early strength accelerator in composite cements.

The method according to the invention is also suitable for the granulation of desulfurization slags, which arise as follows. Pig iron coming from the blast furnace has a high sulfur content and is therefore subjected to desulfurization. For this purpose, the pig iron is placed on pans and mixed with calcium carbide and calcium oxide. The calcium reacts with the iron sulfide (FeS) and the sulfur is converted into the slag as calcium sulfide (CaS). The slag is then removed. The problem here is that calcium sulfide is partially soluble in water and thus presents a hazard to groundwater. For this reason, the desulfurization slag must usually be disposed of in sealed special dump sites. Furthermore, the desulfurization slag is dangerous because the remaining calcium carbide fraction reacts with water to form the highly inflammable gas acetylene.

When granulating the desulfurization slag using a granulation water acidified in particular with sulfuric acid and under oxidizing conditions, the carbon content is converted from the calcium carbide content of the slag into water gas and Ca(OH)₂/CaO. CaS is converted into Ca(OH)₂/CaO and H₂S. H₂S can, for example, be converted to elemental sulfur in the Claus process, or it can be oxidized and hydrolyzed to sulfuric acid based on the high H₂S partial pressure.

As already mentioned, it is also possible to use various organic acids instead of sulfuric acid, wherein the carboxyl group of the respective organic acid apparently has a positive complexing effect on the alkaline earth ions (Ca, Mg), which increase the number of defects in the slag glass. In addition, the hydrolyzing action of the granulating water is thereby further reduced and thus the slag reactivity in the cement is increased.

Within the scope of the invention, it can be provided that the pH value of the water is lowered by the addition of the acid. The pH value of the granulating water is thus regulated by adding an acid or acid mixture. With regard to the chemical reactions occurring during the granulation, in the chemical reactions described above, the corresponding acid consumption is to be replaced by the addition of new acid into the granulating water. It is preferably possible to proceed in such a way that the pH value of the water is measured and the supply of the acid is regulated in order to maintain a predetermined pH value of the water. Thus, a pH value control loop is provided to ensure a predetermined pH value. The pH value specification is based on the respective circumstances. For example, the stoichiometry of the salt formation reactions can be adjusted via the pH-controlled acid addition.

In conventional water granulation, the granulating water has a pH of about 8-11. This basic value results from the partial hydration of the melt in the water bath, wherein Ca(OH)₂ is formed. The addition of acid in the case of granulation of blast furnace slag is preferably performed in such an amount that the pH value of the granulating water is lowered to a value of approximately 6-8. In the case of the addition of sulfuric acid, Ca(OH)₂ is set by the sulfuric acid and thereby neutralized, producing a thin gypsum skin on the slag particle surface.

The lowering of the pH value of the water caused by the addition of acid occurs in particular in regions of the water bath in which the acid has not yet reacted with the melt or the granulate. Such regions can be located in the immediate vicinity of the acid feed, preferably separated from the water feed, or along a flow path in which the acid in the granulating chamber is fed to the region of the actual granulation. Preferably, a plurality of pH-value measurements can be performed along the said flow path in order to determine the dynamics of the reaction conversion (kinetics of the sulfation). From this, a criterion for controlling the rotor speed which determines the shear forces can then also be formed. These shear forces significantly influence the speed of the sulfation reaction.

In general, the amount of acid addition depends, among other things, on the chemical composition of the melt to be granulated, in particular on the CaO content of the melt, and on the desired amount of colloidal silica in the granules. Furthermore, the amount of acid addition depends on the throughput of the melt, i.e., on the amount of melt introduced into the granulating chamber per unit of time. A preferred method provides, in the case of the addition of sulfuric acid, that H₂SO₄ is added in an amount of 2-15% by weight, in particular 2-10% by weight, per unit of time, based on the weight of molten material added in the unit of time.

The acid is preferably added continuously to the water.

In the granulation of steel mill slag, a larger quantity of acid, in particular sulfuric acid, is required to lower the pH value of the granulating water compared to the granulation of blast furnace slag. Steel mill slag contains free CaO and FeO, which reacts with sulfuric acid, so that a partial quantity of the sulfuric acid added can actually be used for the pH value reduction. Preferably, the pH value is lowered to a value of approximately 5-6 by the addition of acid and is maintained at this value by means of the above-described pH value control loop.

Within the scope of the method according to the invention, a temperature reduction of the mineral melt below its recrystallization temperature and salt decomposition temperature is achieved by the evaporation of water, wherein the water vaporization enthalpy is of decisive importance here. The molten material is preferably introduced into the granulating chamber at a temperature of 1,250-1,700° C. and cooled abruptly.

In addition to water evaporation, the strongly endothermic heterogeneous water gas reaction can also be used to improve the cooling performance. The method is preferably performed in this context in such a way that carbon and/or carbon-containing compounds, such as, for example, hydrocarbons, are introduced into the granulating chamber in order to effect a water gas reaction. In addition to the advantage of the improved cooling, the water gas reaction effects the production of economically usable gaseous products, such as, in particular, CO and H₂. Here, the sensible slag heat (about 450 kWh/t) is partly converted into chemical energy in a very advantageous manner.

The supporting water gas reaction is also very advantageous if certain slag portions are to be reduced “in situ”. The water gas reaction causes, for example, a reduction of chromium (VI) oxide to chromium (III) oxide. Zn metallization, nickel salt reduction and phosphate reduction can also be performed.

The granulating water provided in the granulating chamber can be configured as a water bath into which the molten material is poured. The water bath is maintained here at such a temperature that the thermal energy introduced by the molten liquid leads to an evaporation of the granulating water with simultaneous quenching of the melt. It is preferably provided here that the molten material is introduced into a water bath brought to boiling temperature. The introduction of the melt preferably takes place through the interior of a dip tube opened below, immersed in the water bath.

Alternatively, it can be provided that the liquid granulating water is only kept in a bottom region of the granulating chamber in a sump. In this case, the molten material is preferably introduced above the sump which is preferably brought to below the boiling temperature, i.e., is not poured directly into the water. The thermal energy brought with the introduced melt evaporates the water of the sump and superheated steam is generated. In this embodiment, the solidified melt particles are withdrawn together with the superheated steam via a discharge opening, and the melt granules are separated from the H₂O vapor in a separator, such as, for example, in a cyclone separator. The separated superheated but depressurized steam is exegetically valuable and can be recycled accordingly. The deposited pulverulent hot granulate is preferably cooled to below 100° C., for example, by means of air.

The withdrawn water vapor stream with the granulate should preferably have a temperature of 200-600° C. The temperature control is preferably effected here by adjusting the quantity of water introduced into the granulating chamber. For this purpose, a target value of the temperature of the withdrawn water vapor is predetermined and the temperature of the water vapor is measured, wherein the measurement can take place, for example, at the outlet of the separator (e.g., cyclone separator). If the target value is exceeded, the amount of water introduced into the granulating chamber is increased. If the target value is undershot, the amount of water introduced into the granulating chamber is reduced.

In order to achieve particles as fine as possible, the granulation of the melt can preferably be performed such that the molten material in the granulating chamber is subjected to a mechanical disintegration by means of a disintegrator. The expanding water vapor here additionally supports the grinding work. Preferably, the molten material is applied directly to the disintegrator. The mechanical disintegration is advantageously performed by means of a rotor, which is preferably arranged directly under the feed point of the molten material so that the material impacts on the rotor in the molten state. The rotor can be arranged here in such a way that its axis of rotation is substantially aligned with the introduced melt jet. Furthermore, it is preferred when the site of the impact of the melt onto the rotor is essentially kept free of liquid granulating water, in particular by the said dip tube.

The disintegrator is provided in order, among other things, to exert shear forces on the introduced melt. When the disintegrator is configured as a rotor, the melt is thrown radially outwards by the rotation and is further divided in this way. The disintegrator, in particular the rotor, preferably has guide elements, such as, for example, blades, on which cavitation is induced. The cavitation is favored on the one hand by the shear forces which the slag is subjected to due to the centrifugal forces, on the other hand by the sudden evaporation of the granulating water. Steam explosions are produced in the micro range, followed by implosions, resulting in an extremely intensive comminution of the granulate particles which form. The high grinding fineness of the slag particles obtained in this way increases the hydraulic activity potential, so that a cement-technological use is favored.

A further increase in the fineness of the obtained granules can preferably be achieved by vibrating the disintegrator, in particular the rotor, axially back and forth in the direction of the axis of rotation. Preferably, a frequency of the reciprocating motion of >100 Hz, preferably >500 Hz, preferably >1 kHz, in particular >20 kHz (ultrasound) can be selected.

In order to reduce the high thermal load on the rotor, in particular in the area of the feeding of the molten material, a preferred method of operation provides for the water to be passed through axial perforations of the rotor or through at least one radially extending channel of the rotor, whereby cooling of the rotor can be achieved. In addition, an additional cooling effect is exerted on the molten material because the water conducted through the rotor is available as additional granulating water after its exit into the granulating chamber, the evaporation enthalpy of which brings about an additional cooling effect.

The slag granulate can be cooled in the granulating chamber to a temperature of approximately 150-300° C., wherein the vaporous granulating water is passed upwards together with the mostly porous granules formed in the possibly boiling water bath. The gaseous granulating water can be withdrawn together with the reaction gases, for example HF, CO, H₂ and SO₂, via a gas exhaust. Furthermore, part of the possibly boiling granulation water (granulate brine) can be withdrawn continuously over an overflow together with the above floating granules. The superheated melt particles are freed from the film water by dripping and evaporation processes, which leads to a further increase in the hydraulics since they cannot hydratize. The withdrawn granulate brine can be fed to the granulating chamber again as a return water. The granulate brine contains dissolved solid constituents, such as, for example, heavy metals, FeSO₄, Na₂SO₄ and the like, which concentrate on account of the circulation of the water. If necessary, the above-mentioned dissolved constituents are separated and discharged from the circulation by means of a suitable separation unit, such as, for example, a filter, screen, cyclone, a centrifuge or the like.

Likewise, according to a preferred method variant, it can be provided that the evaporated granulating water is conducted after a condensation into the circuit and brought to boiling temperature after the return.

A particularly preferred method variant provides that the granulating chamber is configured as a grinding mill and the molten material is quenched with metallic grinding media of the grinding mill and the solidified material particles are ground by the action of the grinding media.

In a preferred procedure, the acid is added to the granulating water at a point where the molten material has already been subjected to partial cooling so that the acid remains below its decomposition temperature. The addition of the acid at a point which is cooler than the melt feed effects a reduction in the decomposition of the acid (in the case of H₂SO₄, a decomposition into SO₃ and H₂O is thereby avoided). In a configuration in which the melt is applied to a rotating disintegrator, the acid feed can take place at a point which is located further outwards radially relative to the central melt feed. In one embodiment, the melt can be introduced with a rotating disintegrator (rotor) arranged above a sump of granulating water, for example via lines running in the interior of the rotor, which open at a radial distance from the axis of rotation on the surface of the rotor. Alternatively or additionally, the acid addition can also take place in the counter current flow to the particles which are centrifuged radially outwards by the rotor, for example by injection of the acid into the granulating chamber.

According to a further aspect of the invention, a device for performing the method according to the invention is provided comprising a granulating chamber with a water basin for receiving a water bath or sump, a feeding device for the molten material, a water feed opening into the water basin, a feed for the acid and a discharge opening for the granulated material.

A preferred embodiment provides for a sensor for determining the pH value of the water held in the water basin, which cooperates with a quantity regulation of the acid feed in order to maintain the pH value of the water at a predetermined value.

The feeding device for the molten material advantageously comprises a dip tube protruding into the granulating chamber.

A preferred embodiment provides that a disintegrator, in particular a rotor, is arranged in the granulating chamber in the region of the material feed. The disintegrator, in particular the rotor, is here preferably arranged in the water bath or adjacent to the sump.

Furthermore, provision can be made for the rotor to have axial perforations or at least one channel extending in the radial direction for the passage of water. In particular, the rotor can have a channel which opens out preferably into the feed region of the molten material for the introduction of reactive gases and/or water vapor.

A particularly preferred embodiment provides that, instead of a separate disintegrator arranged in the granulating chamber, metallic grinding media are responsible for the supporting disintegration of the solidifying particles. The embodiment is made here in such a way that the granulating chamber is configured as a grinding mill filled with metallic grinding media. The molten material is thus introduced into a grinding mill and quenched in contact with metallic grinding media of the grinding mill and the solidified material particles are ground by the action of the grinding media. Preferably, the grinding mill has a housing formed by a rotatably drivable drum and is configured, in particular, as a ball mill, fall mill, drum mill, tube mill or screen drum mill.

On account of the quenching of the molten material on metallic grinding media, the melt cools extremely rapidly under the recrystallization temperature, so that a hydraulically active, amorphous product with particularly high cement-technological activity is produced. The rapid cooling is achieved by the fact that the metallic grinding media provide an extremely large surface so that a rapid enlargement of the specific surface area of the melt volume takes place upon contact of the melt in order to be able to dissipate the heat as quickly as possible. Another reason for the rapid cooling is the high volumetric heat capacity, i.e., the heat capacity related to the volume, of the grinding media due to its material, namely metal.

At the same time, the solidifying melt particles are comminuted by the grinding action of the grinding media, whereby the surface available for heat transfer is also enlarged.

The simultaneous quenching and comminution by the grinding media also leads to the fact that a substantial part of the comminution work already takes place in the molten state, so that the specific grinding work is reduced to about half as compared with comminution in the solid state.

The slag melt is cooled (quenched) on the cold grinding media and therefore does not come into contact with liquid water, which leads to the known pre-hydration of cement-hydraulically active amorphous slags (CSH phase formation). In addition, the highly superheated, unpressurized water vapor that is possibly present in the grinding space activates the cement-technological potential. The above-described grinding action of the grinding media, in particular the shearing forces caused by the latter, significantly reduce the molecular short-range states, which leads to a further increase in the metastable system state of the slag. In particular, a strong and very advantageous increase in the slag cement early strength can be determined. Thus, the cement clinker content of mixed cements can be drastically reduced and also the very advantageous clinker-free, sulfate cement activation (“super-sulfated cementing”) can be performed.

The cooling power required to quench the molten material introduced is generated by the evaporation of water to which an acid has been added according to the invention. The cooling takes place here by the heat of evaporation on the surface of the grinding media, so that the grinding media are correspondingly cooled. The cooling power required for the quenching of the molten material is thus made available indirectly, through evaporation heat, under mediation of the grinding media. The grinding media are used here as “intermediate carriers” which provide the required heat capacity and thermal conductivity, the required surface area and the required volume for increasing the heat transfer. In this case, the metallic grinding media are cooled on the one hand by the heat of evaporation of the water and, on the other hand, the corresponding quantity of heat is again brought into contact with the molten material for cooling the same.

To cool the grinding media by utilizing the heat of evaporation, it is preferably provided that the pH value regulated water or steam according to the invention is introduced by a plurality of perforations in the grinding space of the grinding mill, which are configured in an inner jacket which delimits the grinding space. The mill is preferably configured here as double-walled construction, wherein an annular cavity is configured between the inner jacket and an outer jacket, which cavity can be filled with water. A water bath is formed here, the level of which is chosen such that a lower partial region of the grinding media bed is arranged in the water bath. On account of the heat effect, the water located in the annular cavity is brought to evaporation and thereby enters into the grinding space via the perforations formed in the inner jacket, where the required heat of evaporation removes heat from the grinding media and cools it. On account of the perforations, a uniform water or steam entry is obtained via the grinding media bed (in particular in the axial direction of the grinding space). In a preferred manner, the perforations in the cross-section can be configured to converge towards the grinding space or form nozzles, in particular, slot nozzles configured extending over the axial length of the grinding space, which leads to a pressure distribution and therefore to an equalization of the water or steam entry into the grinding space.

A preferred secondary effect of the water or steam introduction via the inner jacket provided with perforations is that the grinding media can thereby be made to vibrate, thereby improving the grinding effect and reducing the occurrence of the Leidenfrost effect.

A further preferred embodiment provides that metal balls, in particular steel balls, are used as grinding media, the diameter of which is preferably at least 15 mm, in particular at least 20 mm. In this way, the balls provide a sufficient mass to ensure the required grinding performance. Furthermore, this enables a simple, large-scale distinction between the grinding media and the ground feed material, which facilitates, for example, subsequent separation steps.

In principle, all metal balls can have the same size. An optimization of the grinding action can, however, preferably be achieved by the metal balls having a predetermined size distribution. In this case, a size band width is preferred in which the ball diameter is between 15 and 30 mm.

In order to ensure an efficient grinding action, the configuration is preferably further developed in such a way that the metal balls are set in motion to form a moving ball bed. The configuration of the moving ball bed can take place in a variety of ways. The balls can, for example, be moved by the effect of the flow of a gaseous medium such as, for example, air or steam. Alternatively or additionally, the movement of the metal balls can be produced by the balls being set into motion by moving drivers, for example, by an agitator, vanes, guide plates or the like. Alternatively or additionally, the grinding space can be formed by a rotatably driven drum, on the wall of which the balls rise and fall down due to gravity. In this context, the invention preferably provides that the grinding mill is configured as a ball mill, fall mill, drum mill, tube mill, agitator ball mill or screen drum mill. As with all grinding mills, grinding media and grist are moved in the ball mill. As a result, there are impacts between the grinding media and between grinding media and walls. The grist is comminuted when it is between the bodies. The comminution of the particles thus occurs by impact, shear and shock stress.

The invention is explained in more detail below with reference to exemplary embodiments shown schematically in the drawing.

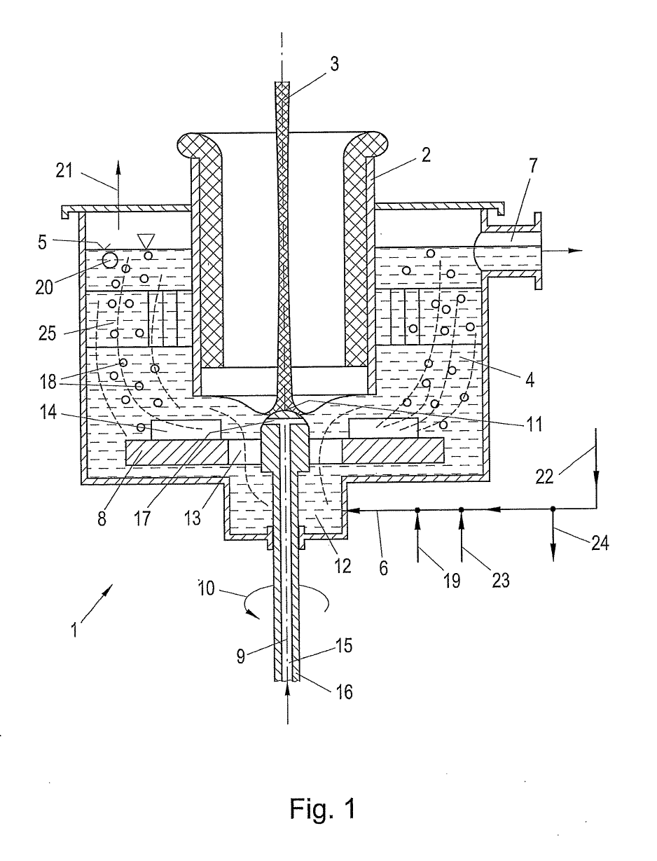

In these, FIG. 1 shows a first embodiment of a granulating device for performing the method according to the invention,

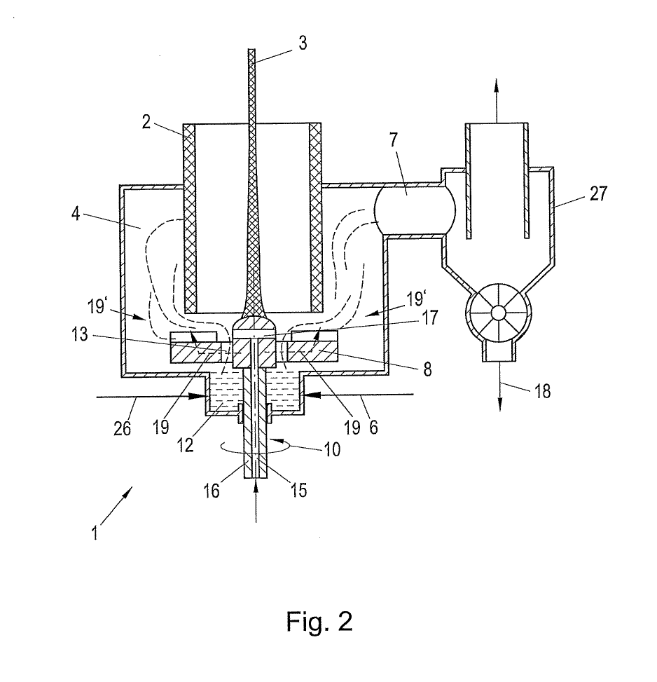

FIG. 2 shows a second embodiment of a granulating device,

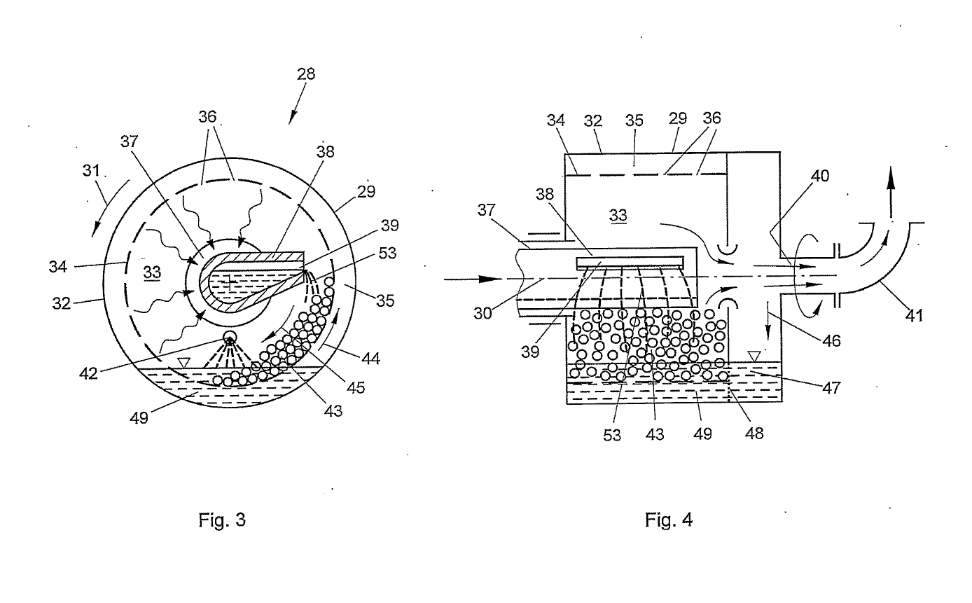

FIG. 3 a cross section of a granulating device configured as a ball mill,

FIG. 4 a longitudinal section of the device according to FIG. 3 and

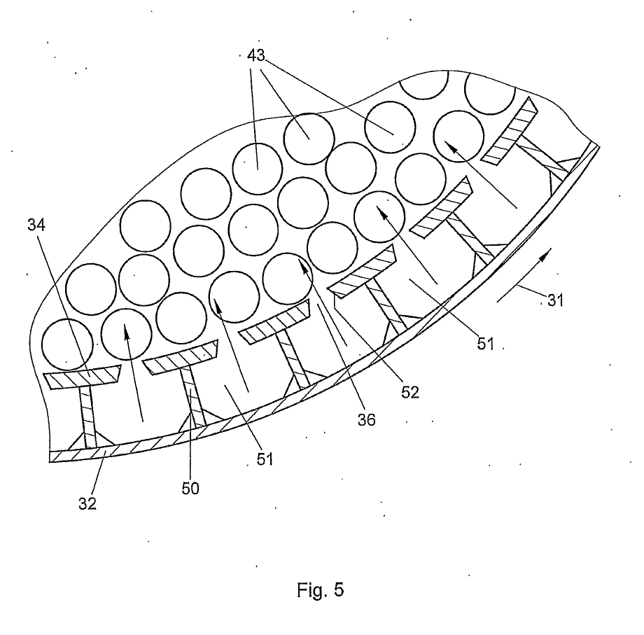

FIG. 5 is an enlarged detail view of the device according to FIGS. 3 and 4.

FIG. 1 shows a granulating device 1 which has a feeding device for molten material 3 configured as a dip tube 2. In the interior of the granulating device 1, a granulating chamber 4 is configured, in which a water bath with a water surface 5 is accommodated. A water feed 6 opens into the water bath. The granulated material is discharged via a discharge opening 7.

The dip tube 2 immerses into the water bath to just above a disintegrator configured as a rotor 8, so that the melt jet 3 introduced through the dip tube 2 impacts directly on the rotor 8 or only a small water layer passes through, but it evaporates abruptly. The rotor 8 is rotatably mounted about a rotational axis 9 and is driven for rotation according to the arrow 10. The slag jet 3 is preferably introduced centrally, as shown in FIG. 1, i.e., in the region of the rotational axis 9 of the rotor 8. In the center 11 of the rotor 8, the latter has a rounded or convex region, on which the melt jet 3 impacts and is thrown outwards therefrom on account of the rotation. The rotor 8 is arranged essentially at the bottom of the granulating chamber 4. In a radially inner, central partial region of the rotor 8, a sump or a mixing chamber 12, however, is configured below the rotor 8, which forms a recessed region of the granulating chamber 4 and is filled with water. The rotor 8 has axial perforations 13, through which the water is sucked out of the mixing chamber 12.

The rotor 8 has guide surfaces 14, which act as a cavitator, radially outside the axial perforations 13. The granulating water is provided at a temperature such that it vaporizes abruptly in the region of the introduction of the melt jet 3 or in the region of the rotor 8 due to the thermal energy introduced with the melt. The expanding steam together with the mechanical forces caused by the rotor 8, in particular shearing forces, cause a grinding effect on the solidifying melt particles, so that an extremely fine-grained granulate is formed. At the guide surfaces 14, the expanding steam, in conjunction with the said forces, leads in the micro region to steam explosions, followed by implosions, i.e., to cavitation, whereby an extremely intensive comminution of the forming granules particles is achieved.

For cooling the central region 11 of the rotor 8, a feed channel 15 is provided which runs inside the shaft 16 of the rotor 8 and is radially deflected in the central region 11 for the formation of radial channels 17. Water or steam can be supplied for cooling the central region 11 of the rotor 8 via the feed channel 15 and the radial channels 17, for example. Reactive gases such as, for example, O₂, air, Cl₂, SO₂, CH₄ and/or coal dust or hydrocarbons can further be introduced together with air/O₂ or water via the feed channel 15 and the radial channels 17.

The solidified melt particles 18 leave the rotor 8 in the radially outer region thereof and rise due to their low density in the preferably boiling water bath. In this case, a guide apparatus 25 can be provided, which comprises, for example, blade bodies. At the bath surface 5, the solidified melt particles 18 are discharged together with the granulating water via the discharge opening 7 configured as an overflow.

The gaseous constituents are removed via a reaction gas withdrawal system, which is shown schematically at 21, wherein it is water vapor and, for example, HF, CO, H₂ and SO₂.

An acid, in particular sulfuric acid, is now added to the water bath. The acid is added via the water feed 6. The acid is added to the water to be fed into the mixing chamber 12 at 19. The quantity control of the acid admixture is effected as a function of measured values of a pH sensor 20 in such a way that a predetermined pH value of the water bath is achieved or maintained or as a function of the chemical composition of the melt and of the melt flow rate.

The water supply is fed by return water, which is extracted from the discharge opening 7. The granulate brine withdrawn via the discharge opening is subjected for this purpose to at least one separating step in which the granules obtained are separated off. The return water obtained in this way is recycled via line 22. To compensate for evaporated water, the water recycled is mixed with 23 additional water.

A portion of the water at 24 can be discharged for the separation of components contained in the return water, in particular dissolved therein, like, for example, FeSO₄, Na₂SO₄ and various heavy metals.

In the modified embodiment according to FIG. 2, the granulating water is presented as a sump only in the chamber 12 below the rotor 8. The water is introduced into the granulating chamber via line 6 at a temperature below the boiling temperature. Carbon and/or hydrocarbons can be introduced into the sump via the line 26 in order to effect a water gas reaction in the granulating chamber 4 in addition to the granulation (with the aid of the water evaporating from the chamber 12). In this embodiment, the solidified melt particles are withdrawn together with the water vapor and the forming water gas via the discharge opening 7, and the melt granules 18 are separated in the cyclone separator 27 from the reaction gases (CO/H₂) and from the H₂O vapor. Pressurized water can be introduced via the channel 15.

In the embodiment according to FIG. 2, the acid addition can take place directly into the granulating chamber, i.e., without prior admixture into the water 6. The acid is preferably fed via channels running in the rotor 8 which open at a distance from the axis of rotation on the surface of the rotor, i.e., at a point at which a temperature below the decomposition temperature of the acid prevails. The addition of the acid is indicated at 19. Alternatively or additionally, the acid can also be introduced via nozzles 19′, by means of which the acid is injected into the granulating chamber in counter current flow to the granulate in the radially inward direction.

FIGS. 3 and 4 show a granulating device configured as a ball mill. FIG. 3 shows a ball mill 28 in cross section, the cylindrical drum 29 of which is rotatably mounted about the axis of rotation 30. In operation, the drum 29 is driven to rotate in the direction of the arrow 31. The drum 29 has an outer jacket 32 and an inner jacket 34 delimiting the grinding space 33. Between the outer jacket 32 and the inner jacket 33, an annular cavity 35 is formed, which is connected to the grinding space 33 via a plurality of preferably slot-shaped perforations 36 distributed regularly over the circumference of the grinding space 33.

A slag inlet 37 opens into the grinding space 33 coaxially with the axis of rotation 30, wherein the slag inlet has a slag tundish 38 arranged centrally in the interior of the grinding space 33, the slit-shaped inlet opening 39 of which extends in the axial direction of the drum 29 and is arranged eccentrically within the grinding space 6.

On the side opposite the slag inlet 37, the drum 29 has a discharge opening 40 coaxial with the axis of rotation 30, to which a discharge line 41 is connected (FIG. 4).

Instead of the inner jacket 34 provided with perforations, or in addition to this, a spraying bar 42 extending in the axial direction of the drum 29 is arranged in the interior of the grinding space 33, the spray openings of which are directed downwards.

A metal ball bed 43 is provided in the interior of the grinding space 33, the metal balls, in particular steel balls, forming the grinding media of the ball mill 28. In the operation of the ball mill 28, the metal balls are carried upwards (arrow 44) by the drum 29 rotating in the direction of the arrow 31, as shown in FIG. 3, and fall down again after reaching a critical height due to gravity (arrow 45).

In the operation of the ball mill 28, as indicated at 46, water is passed into a water feed annular chamber 20 arranged in the drum 29, which is separated from the grinding space 33 by a diaphragm 48. The diaphragm 48 is configured so as to be liquid-permeable only in the region of the water feed annular chamber 47 so that the water feed annular chamber 47 feeds a water bath 49 configured in the grinding space 33 and which is always located in the bottom region of the drum 29. In particular, the water of the water bath 49 fills the annular cavity 35 between the outer jacket 32 and the inner jacket 34 of the drum 29. As can be seen in the detailed view according to FIG. 5, the annular cavity 35 has a plurality of partition walls 50 running in the axial direction of the drum 29 so that a plurality of chambers 51 adjoining one another in the circumferential direction are configured in the annular cavity 35. Each chamber 51 is thereby connected to the grinding space 33 via a slot-shaped perforation 36, wherein the slot-shaped perforations 36 have walls 52 converging towards the grinding space 33, so that there is a nozzle effect.

When the drum 39 is rotating, blast furnace slag 53 is introduced into the grinding space 33 having a temperature of 1300-1600° C. via the slag tundish 38, wherein the blast furnace slag 53 reaches the ball bed 43, which has a temperature of at most 400-600°. The slag is cooled abruptly on the surface of the metal balls of the ball bed 16. At the same time, due to the movement of the balls, the slag is broken down into solidifying particles. The solidifying particles are further comminuted by the grinding effect of the ball bed 43 until they have a minimum upper grain limit of, for example, 60 μm, in order to be able to be discharged from the ball mill 28. The particles are cooled in the ball mill 28 to the extent that they have a temperature of 600-800° C. or lower at discharge. The ball mill 28 can be configured in such a way that it has at least two grinding spaces adjoining each other in the axial direction and which are connected to each other by a screening device and grinding media of which are dimensioned such that a higher grinding fineness is achieved in each grinding space. Alternatively, a mill cascade is also conceivable. The longer the residence time of the particles in the mill, the further the ground particles are cooled, so that the exergetic utilization can be further improved.

Simultaneously with the cooling of the slag at the spherical surfaces, a continual cooling of the metal balls is effected by the action of the water bath 49. The water is evaporated by the heat introduced with the slag, wherein evaporation heat is required, which is withdrawn from the metal balls for the purpose of cooling them. The evaporating water escapes in this case from the chambers 51 via the perforations 36 configured as slot nozzles due to the abrupt volume increase, wherein the nozzle effect leads to an axial uniformization of the outflowing steam quantity due to the pressure gradient. The steam flowing out of the chambers 51 leads to an additional mechanical effect on the balls of the ball bed 43, so that they are excited to vibrations, which improves the grinding effect.

A mixture of hot steam and the dust of the ground slag particles forms in the interior of the grinding space. The hot steam/dust mixture is discharged via the discharge opening 40 and the discharge line 41.

1-22. (canceled)

23. A method for granulating molten material comprising a slag having, as its main constituents, CaO: >30% by weight, SiO2: >30% by weight, and Al₂O₃: >6% by weight, in particular blast furnace slag, the method comprising introducing the molten material into a granulating chamber, wherein the granulating chamber includes water as a cooling liquid, quenching and granulating the molten material to obtain latent hydraulical particles, adding an acid to the water, wherein the water is in a water bath or the granulating chamber includes a sump and the molten material is introduced into either the water bath brought to boiling temperature or introduced above the water in the sump brought to boiling temperature, and subjecting the molten material in the granulating chamber to a mechanical disintegration by means of a disintegrator.

24. The method according to claim 23, wherein the acid comprises a mineral acid, an organic acid or a mixtures thereof.

25. The method according to claim 23, wherein the method further comprises measuring pH value of the water and regulating the feed of the acid to the water to maintain a predetermined pH value of the water.

26. The method according to claim 23, wherein the mechanical disintegration is performed by means of a rotor.

27. The method according to claim 23, wherein the disintegrator is arranged at least partially in the water bath or adjoining the sump.

28. The method according to claim 26, wherein the rotor has an axis, and either the rotor has axial perforations and water is conducted through axial perforations of the rotor or the rotor has at least one channel extending in the radial direction from the axis of the rotor and water is conducted through the at least one channel of the rotor.

29. The method according to claim 23, wherein in the method water is evaporated while the molten material is quenched and granulated, and the method further comprises condensing the evaporated water, recirculating the thus condensed water to the granulating chamber and bring the water to boiling temperature after being returned to the granulating chamber.

30. The method according to claim 23, wherein the granulating chamber is configured as a grinding mill and the molten material is quenched with metallic grinding media of the grinding mill and the solidified material particles are ground by the action of the grinding media.

31. The method according to claim 24, wherein the inorganic acid comprises sulfuric acid, hydrochloric acid, nitric acid or phosphoric acid; and the organic acid comprises formic acid, acetic acid, stearic acid or ligninsulfonic acid.

32. The method according to claim 31, wherein the method comprises introducing carbon and/or carbon-containing compounds into the granulating chamber for effecting a water gas reaction in the granulating chamber.

33. A device for performing the method according to claim 23, said device comprising a granulating chamber having a water basin for receiving a water bath and/or a sump for water, a feeding device for feeding the molten material into the granulating chamber, a water feed opening into the water basin and/or the sump, a feed for the acid and a discharge opening for the granulated material, wherein a disintegrator, in particular a rotor, is arranged in the granulating chamber in a region where the molten material is fed into the granulating chamber.

34. The device according to claim 33, wherein the device further comprises a sensor for determining the pH value of the water in the granulating chamber, which, together with regulating the quantity of the acid feed to the water, is for maintaining the pH value of the water at a predetermined value.

35. The device according to claim 33, wherein the feeding device for the molten material comprises a dip tube protruding into the granulating chamber.

36. The device according to claim 33, wherein the disintegrator comprises the rotor, and the rotor is arranged in the water bath or adjacent to the sump.

37. The device according to claim 36, wherein the rotor has a vertical axis, and the rotor has axial perforations or at least one channel extending in the radial direction from the vertical axis for the passage of water.

38. The device according to claim 37, wherein the rotor has a channel, which opens out preferably into the region where the molten material is fed into the granulating chamber, for the introduction of reactive gases and/or water vapor.

39. The device according to claim 33, wherein the granulating chamber is configured as a grinding mill filled with metallic grinding media.

40. The device according to claim 39, wherein the grinding mill has a housing formed by a rotatably drivable drum and is configured as a ball mill, fall mill, drum mill, tube mill or sieve drum mill.

41. The device according to claim 39, wherein the grinding media comprise metal balls, the diameter of which is at least 15 mm.

42. The device according to claim 39, wherein the grinding mill has an inner jacket which delimits the grinding space and is provided with perforations, and an outer jacket, wherein the inner and outer jackets delimit an annular space which configures the water basin and is connected to the water feed.
